(19) United States
(12) Patent Application Publication
(10) Pub. No.: US 2026/0330413 A1
(43) Pub. Date: Oct. 22, 2026

(54) SYSTEMS AND METHODS FOR LARGE LANGUAGE MODEL-BASED IDENTIFICATION OF PROJECT INTERDEPENDENCIES, BOTTLENECKS, AND EARLY RISK DETECTION

(71) Applicant: JPMORGAN CHASE BANK, N.A., New York, NY (US)

(72) Inventor: Shun Kit KWAN, Bournemouth (GB)

(21) Appl. No.: 19/180,961

(22) Filed: Apr. 16, 2025

(51) Int. Cl. G06Q 10/10; G06F 16/3329; G06Q 10/0635

(52) U.S. Cl. CPC G06Q 10/103; G06F 16/33295; G06Q 10/0635

(57) ABSTRACT

Systems and methods for large language model-based identification of project interdependencies, bottlenecks, and early risk detection are disclosed. A method may include: receiving and ingesting structured data and unstructured data from a data source for a project; providing the ingested structured data to a dependency graph construction module; generating a Directed Acyclic Graph (DAG) and cluster information from the ingested structured data; providing the ingested unstructured data to an insights extraction module; identifying features and labels from the ingested unstructured data; outputting the features and labels to a dependency graph enrichment module; enriching the DAG with the features and labels, resulting in an enriched DAG and enriched cluster information; making the enriched DAG and the enriched cluster information available to a user electronic device; receiving user feedback from the user electronic device; and providing, by the computer program, the user feedback to the data ingestion module.

### BACKGROUND OF THE INVENTION

### 1. Field of the Invention

Embodiments relate to systems and methods for large language model-based identification of project interdependencies, bottlenecks, and early risk detection.

### 2. Description of the Related Art

Project Managers (PMs) typically use Critical Path-based Methods (CPMs) to manage task dependencies and critical events in projects. Project and task tracking systems may allow PMs to input inter-project dependencies, but they are often manual and based on structured data fields, such as Task IDs, due dates, status indicators, severity, and dependency matrices. At the same time, PMs often prepare textual status reports and documents to highlight accomplishments, risks, and issues in plain language or technical terms. These narrative reports provide valuable insights but are typically unstructured, making it difficult to integrate them with structured data fields. These approaches either increase the likelihood of missed information (due to manual input) or could be overly complex, making it challenging to gain a comprehensive view, especially in a multinational organization where hundreds of critical events could occur each month.

When issues arise (e.g., an external supplier delays or unexpected resource constraints in a team), conventional risk management and escalation mechanisms-reporting, escalation emails, awareness in a steering committee tend to be slow and reactive. In addition, while each PM reports the issue/risk in the system as part of standard procedure, the descriptions could vary, and the documentation in each individual project leads to duplications and requires senior stakeholders to invest additional time in interpreting the reports and conducting thorough analysis on the root cause.

Projects are often organized under broader programs, which adds another layer of complexity. Programs typically encompass multiple related projects, each with its own set of tasks, dependencies, and objectives. In multinational organizations, where programs may span different regions and involve diverse teams, this complexity is further compounded. Program stakeholders need accurate project updates, but the repetition of information across various platforms and layers increases the risk of miscommunication.

### SUMMARY OF THE INVENTION

are disclosed. In one embodiment, a method may include: receiving, by a computer program executed in a platform, structured data and unstructured data from a data source for a project; ingesting, by a data ingestion module, the structured data and the unstructured data; providing, by the computer program, ingested structured data to a dependency graph construction module; generating, by the dependency graph construction module, a Directed Acyclic Graph (DAG) and cluster information from the ingested structured data; providing, by the computer program, the ingested unstructured data to an insights extraction module; identifying, by the insights extraction module, features and labels from the ingested unstructured data; outputting, by the insights extraction module, the features and labels to a dependency graph enrichment module; enriching, by the dependency graph enrichment module, the DAG with the features and labels, resulting in an enriched DAG and enriched cluster information; making, by the computer program, the enriched DAG and the enriched cluster information available to a user electronic device; enabling, by the knowledge discovery module, users to interact with the enriched DAG through a chat interface by asking questions and obtaining insights; receiving, from a knowledge discovery module, user feedback from the user electronic device; and providing, by the computer program, the user feedback to the data ingestion module.

In one embodiment, nodes of the DAG comprise project elements and edges represent dependencies or relationships between the project elements.

In one embodiment, the dependency graph construction module applies graph theory algorithms to analyze critical paths and identify clusters of project elements with common attributes.

In one embodiment, the insights extraction module comprises a Large Language Model (LLM), wherein the LLM is configured to extract dependencies and relationships across events based on the ingested unstructured data.

In one embodiment, the insights extraction module is trained on historical data to identify bottlenecks and hidden dependencies using machine learning and natural language processing.

In one embodiment, the insights extraction module is configured to integrate graph algorithm outputs to forecast risks and recommend preventive actions based on hidden relationships or indirect dependencies that have been discovered.

In one embodiment, the method may also include: providing, by the computer program, a visualization and chatbot interface on the user electronic device, wherein the visualization and chatbot interface provides analysis via insightful visualizations.

In one embodiment, the structured data comprises a program table for a program, a project table for a project in the program, a task table for tasks in the project, a risk table for risks in the project, an issue table for risks in the project, and a status report table for a status report for the project or program.

In one embodiment, the user feedback comprises explicit user feedback and inferred user feedback, and wherein the computer program updates the DAG graph using the user feedback.

In one embodiment, the method may also include: generating, by the computer program, a dynamic frequently asked questions database based on the user feedback.

According to another embodiment, a non-transitory computer readable storage medium may include instructions stored thereon, which when read and executed by one or more computer processors, cause the one or more computer processors to perform steps comprising: receiving structured data and unstructured data from a data source for a project; ingesting the structured data and the unstructured data; generating a Directed Acyclic Graph (DAG) and cluster information from the ingested structured data; identifying features and labels from the ingested unstructured data; enriching the DAG with the features and labels, resulting in an enriched dependency graph and enriched cluster information; making the enriched DAG and the enriched cluster information available to a user electronic device; and receiving user feedback from the user electronic device.

In one embodiment, nodes of the DAG comprise project elements and edges represent dependencies or relationships between the project elements.

In one embodiment, the non-transitory computer readable storage medium may also include instructions stored thereon, which when read and executed by one or more computer processors, cause the one or more computer processors to perform steps comprising: applying graph theory algorithms to analyze critical paths and identify clusters of project elements with common attributes.

In one embodiment, the identifying features and labels from the ingested unstructured data are identified using a large language model (LLM).

In one embodiment, the non-transitory computer readable storage medium may also include instructions stored thereon, which when read and executed by one or more computer processors, cause the one or more computer processors to perform steps comprising: integrating graph algorithm outputs to forecast risks and recommend preventive actions.

In one embodiment, the non-transitory computer readable storage medium may also include instructions stored thereon, which when read and executed by one or more computer processors, cause the one or more computer processors to perform steps comprising: providing a visualization and chatbot interface on the user electronic device, wherein the visualization and chatbot interface provides analysis via insightful visualizations.

In one embodiment, the structured data comprises a program table for a program, a project table for a project in the program, a task table for tasks in the project, a risk table for risks in the project, an issue table for risks in the project, and a status report table for a status report for the project or program.

In one embodiment, the user feedback comprises explicit user feedback and inferred user feedback, and further including instructions stored thereon, which when read and executed by one or more computer processors, cause the one or more computer processors to perform steps comprising: updating the DAG graph using the user feedback.

In one embodiment, the non-transitory computer readable storage medium may also include instructions stored thereon, which when read and executed by one or more computer processors, cause the one or more computer processors to perform steps comprising: generating a dynamic frequently asked questions database based on the user feedback.

Embodiments relate to a system designed for identifying interdependencies, bottlenecks, and early risk detection across large amounts of project data. Using graph algorithms and Generative AI, embodiments may analyze project data, including descriptions, milestones, risks, and issues, to uncover hidden dependencies and provide actionable insights for project managers. Network graphs and clusters may be created based on structured data fields such as impacted locations, responsible groups, and timeframes.

The graphs may be further enriched using Generative AI and Large Language Models (LLM) to process unstructured data like status reports, issue descriptions, and resolution plans.

According to an embodiment, a system may include a data ingestion module for collecting and standardizing project data; a graph construction module for building and dynamically updating directed acyclic graphs (DAGs) to model project dependencies, and then applying graph theory algorithms to identify critical paths, central tasks, and clusters; a generative AI module for learning patterns from historical data to forecast risks and recommend preventive actions; and a visualization and chatbot interface that provides real-time insights and interactive tools for project managers. This combination of AI-driven analysis and graph-based modelling enhances decision-making and dynamic project risk management.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for large language model-based identification of project interdependencies, bottlenecks, and early risk detection according to an embodiment;

FIG. 2 depicts a method for large language model-based identification of project interdependencies, bottlenecks, and early risk detection according to an embodiment;

FIG. 3 depicts an exemplary data ingestion structure according to an embodiment; and

FIG. 4 depicts an exemplary computing system for implementing aspects of the present disclosure.

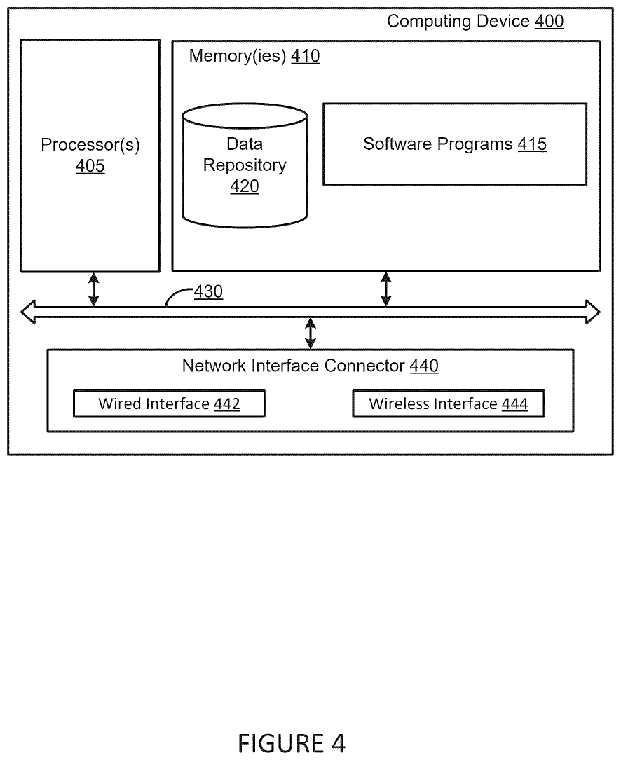

### DETAILED DESCRIPTION OF PREFERRED EMBODIMENTS

Embodiments relate to systems and methods for large language model-based identification of project interdependencies, bottlenecks, and early risk detection.

For example, embodiments may use graph algorithms and Generative AI to analyze project data, including project descriptions, milestones, risks, and issues, to identify hidden dependencies and provide actionable insights for project managers. Network graphs and clusters may be created based on defined data fields (structured data) of the project records, such as impacted locations, responsible groups, defined inter-project dependencies, and timeframes. The graph may be enriched with additional knowledge obtained through Generative AI and Large Language Models (LLM) to process the details of project data, which may be in natural language (paragraphs of unstructured data such as project goals, scope descriptions, etc.).

As each project progresses, more relevant data, such as meeting minutes, status reports, and issue logs, may be fed into the system and processed by LLM to refresh/expand the graph's edges and nodes. The combination of AI-driven analysis and graph-based modelling allows for more comprehensive decision-making and dynamic project risk management.

Embodiments may use generative AI and Large Language Models combined with graph theory to discover hidden inter-dependencies and bottlenecks across a portfolio of projects. Embodiments may analyze large volumes of project data to automatically identify previously unrecognized links, risks, or dependencies through pattern recognition and predictive analysis.

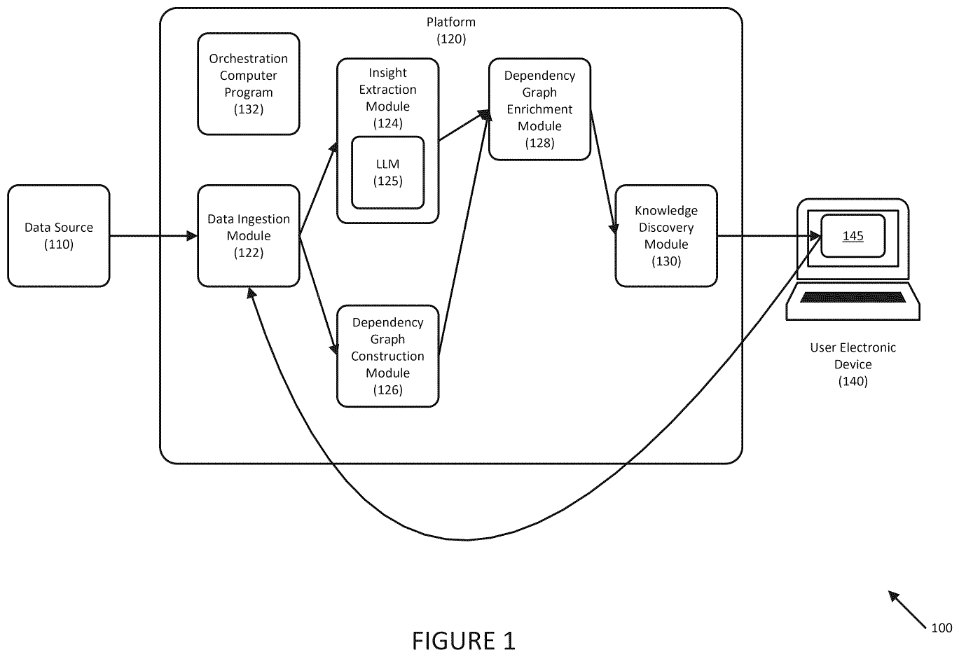

Referring to FIG. 1, a system for large language model-based identification of project interdependencies, bottlenecks, and early risk detection is disclosed according to an embodiment. System 100 may include one or more data sources 110, which may be a source of structured and unstructured project data. Data source(s) 110 may include project management platforms that may provide, for example, project descriptions (e.g., objective, scope descriptions, benefits, stakeholders, schedule, etc.), milestones (description, owner, due date, location, priority, etc.), risks and issues (description, severity, category, owner, resolution plan, etc.), etc.

System 100 may further include platform 120, which may be a cloud-based platform to allow data collection from multiple sources and locations, specifically gathering data from data source(s) 110.

Platform 120 may include orchestration computer program 132, data ingestion module 122, insight extraction module 124, dependency graph construction module 126, dependency graph enrichment module 128, and knowledge discovery module 130.

Orchestration computer program 132 may be a computer program or script that controls or manages the operation of modules provided on platform 120.

Data ingestion module 122 may be a data integration component configured to collect and standardize project-related data into a predefined schema. For example, data ingestion module 122 may be a script, a computer program, etc. Data to be collected may include project descriptions (e.g. objective, scope descriptions, benefits, stakeholders, schedule), milestones (description, owner, due date, location, priority), risks and issues (description, severity, category, owner, resolution plan) from project management platforms.

Insight extraction module 124 may receive unstructured data from data ingestion module and may infer insights, such as features and labels, from the unstructured data. Insight extraction module 124 may include an AI trained model that may be trained on historical project data to learn patterns that indicate bottlenecks (e.g., a node that has a large number of edges) and hidden dependencies. It may also apply machine learning and natural language processing (NLP) algorithms to historical patterns, status updates, task/milestone correlations, etc. to identify the hidden interdependencies between project events. For example, by analyzing historical data, the system can identify recurring delays in specific phases or consistent resource shortages, as well as detect anomalies or deviations from expected project behavior based on the data of other projects with similar scope.

In one embodiment, insight extraction module 124 may include large language model (LLM) 125. LLM 125, which may be a generative pre-trained transformer (GPT) model, may infer hidden relationships that are not explicitly specified in project record. For example, LLM 125 may recognize patterns by scanning through historical project unstructured data and detecting patterns/correlations between projects, it can analyze sequence of similar project phases or milestones to learn that certain types of projects are often delayed when others are, indicating a hidden dependency; may augment dependencies by identifying resources shared between projects that can cause bottlenecks but are not formally recognized; may automatically identify risk continuously analyzing project data steams to flag early risks based on patterns learned from historical projects (e.g., the likelihood of delays or resource shortages), etc.

Insight extraction module 124 may integrate the output from graph construction module 126 to forecast risks and provide recommended actions to prevent them from being materialized.

Dependency graph construction module 126 may be a graph algorithm component that constructs a Directed Acyclic Graph (DAG) where nodes of the DAG may represent project elements (e.g., milestones, tasks, risks, resources, etc.) and edges may represent dependencies, shared entities (e.g., the same resource group, location etc.), or sequential relationships between the project elements. For example, dependency graph construction module 126 may be a script, a computer program, etc.

Each project element may be represented as a node in the DAG. Nodes may be created based on the standardized schema, with each node containing attributes such as identity, name, type, and relevant metadata (e.g., location, resource group, dates, priority, etc.).

Dependency graph construction module 126 may establish hierarchical relationships with the use of parent ID from the schema using the edges. For example, a project node may be connected to its parent program node, and task nodes may be connected to their respective project or program nodes.

Dependency graph construction module 126 may also analyze the structured data to identify dependencies between the nodes. Dependencies may be based on the hierarchical links (e.g., direct parent-child relationships, such as tasks belonging to a project) as mentioned above, or through clustering attributes (e.g., shared attributes such as location, resource group, or date range that imply a dependency or interaction). Dependency graph construction module 126 may create directed edges between nodes to represent these dependencies. For example, if two tasks share the same resource group and overlap in time, an edge can be drawn to indicate a potential resource conflict.

As project data changes over time, dependency graph construction module 126 may dynamically update the DAG to reflect new dependencies or changes in existing ones. This may include re-evaluating the relationships and dependencies whenever new data is ingested or existing data is modified-based on the information submitted by the PMs on a regular basis (e.g., monthly) or triggered by specific events, such as a status trend shifting to amber because of an unexpected issue, which prompts the PM to log the journal and resolution plan.

Dependency graph construction module 126 may then apply graph theory algorithms to the generated project graph to analyze interdependencies and identify potential bottlenecks, including, for example: (i) the shortest path algorithm to calculate the critical path across projects, determining the shortest timeline across inter-dependent tasks (e.g., Dijkstra's algorithm); (ii) centrality measures to identify critical tasks or milestones, by measuring the centrality of tasks in the dependency graph; (iii) clustering algorithms to identify clusters of project elements that share common attributes, such as location, stakeholder, timeframe, etc. ; (iv) Ford-Fulkerson method to determine maximum flow in the graph, helping to identify resource allocation bottlenecks; (v) PageRank algorithm to assess the importance of nodes within the graph, providing insights into tasks or milestones that have significant influence on the overall project flow and outcomes; etc.

Knowledge discovery module 130 may present the analysis to users through an intuitive user interface that visualizes inter-dependencies, risks, and bottlenecks, including libraries (e.g., in order to present the graph, with nodes and edges dynamically updated based on the changes in project data); dashboards to provide real-time insights into project health, with visual indicators for critical dependencies and risks; and a chatbot-type interface to allow project managers to raise questions and simulate ‘what-if’scenarios.

For example, knowledge discovery module 130 may be a script, a computer program, etc.

System 100 may further include user electronic device 140, which may be a computer (e.g., a workstation, a desktop, a laptop, a notebook, a tablet, etc.), a smart device (e.g., smart phone, smart watch, etc.), an Internet of Things (IoT) appliance, etc. In one embodiment, user electronic device 140 may execute user computer program 145, which may receive the output of knowledge discovery module 130.

In one embodiment, user computer program 145 may provide a chatbot interface by which the user may interface with knowledge discovery module 130. User computer program may also present analysis to project managers via insightful visualizations (e.g., 5 Whys, Fish-bone diagrams (Ishikawa Diagrams), etc.).

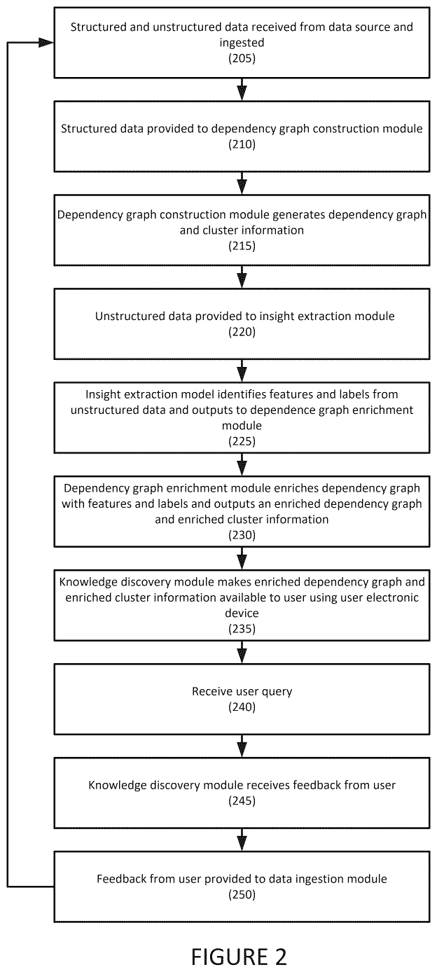

Referring to FIG. 2, a method for large language model-based identification of project interdependencies, bottlenecks, and early risk detection is disclosed according to an embodiment.

In step 205, a computer program, such as an orchestrator, may receive structured and unstructured data from one or more data sources and may ingest the data using a data ingestion module. The data source(s) may include project management platforms that may provide, for example, project descriptions (e.g., objective, scope descriptions, benefits, stakeholders, schedule, etc.), milestones (description, owner, due date, location, priority, etc.), risks and issues (description, severity, category, owner, resolution plan, etc.), etc.

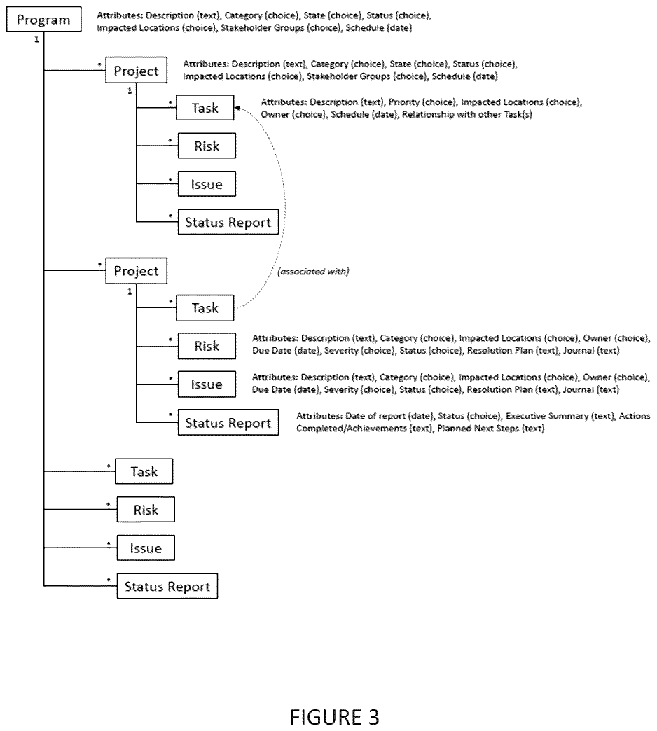

For example, the data ingestion module may ingest data from project management systems in the form of relational databases via APIs, where critical fields may be organized into tables that capture the hierarchical and relational aspects of project management. An exemplary structure is provided in FIG. 3.

An exemplary project with tasks, risks, and issues is illustrated below:
Project: Data Center Decommission
Milestones and Tasks:
   Decommission Plan Approved
      Develop decommissioning plan
   Equipment Decommissioned
      Notify stakeholders and schedule decommissioning
      Safely remove and dispose of equipment
   Site Restored
      Restore site to original condition
Risks:
   Environmental compliance issues during equipment disposal.
   Data security risks during the decommissioning process.
Issues:
   Unforeseen site restoration challenges.
   Coordination issues with disposal vendors.

A program table may include fields at the program level for a project, such as program ID, program name, description, state (e.g., not started, work in progress, on hold, complete), status (e.g., Red/Amber/Green, on track/minor variance to baseline/major variance to baseline, etc.), impacted locations, start and end dates, and associated resource groups.

A project table may include fields at the project level, such as project ID, project name, description, state, status, impacted locations, start and end dates, resource groups, and a parent ID linking each project to its corresponding program.

A task table may include fields at the task level, such as task ID, task name, description, status updates, state (e.g., pending, work in progress, complete, cancelled), type (milestone or task with duration), priority, start and end dates, resource group ownership, and a parent ID indicating the associated program or project.

Risk and issue tables may share a similar structure and may include fields for ID, name, description, category, state, severity, start and due dates, resource group ownership, parent ID, and resolution updates.

A status report table may capture executive key messages, detailed status updates, key achievements, next steps, and paths to green for items marked as red or amber. A program or project can have status reports updated by PMs on a regular (e.g., monthly) basis, which is unstructured (textual) data and is a source of data to enrich the DAG.

In one embodiment, the status report may be similar to a task table, a risk table, or an issue table that belongs to a project. A project manager may provide regular status updates in paragraphs, which may be stored in the Status Report table. Example fields in the status report table may include date of report, status, executive summary (paragraph), actions complete/achievements (paragraph), planned next steps (paragraph). Then LLM may then fetch the data from the textual/unstructured data to get entity, location, relationship information.

Programs, projects, tasks, risks, and issues may be identified as key entities. Relationships may be established through parent ID fields, linking projects to programs and tasks to projects or programs, or through predecessor-successor relationship as specified in the dependency matrices. Structured fields with finite choice values (e.g., resource groups, locations, and dates) may be parsed to establish definitive links and identify connections among various project elements. This may result in a comprehensive view of project interdependencies and facilitate the identification of critical paths and potential bottlenecks. Embodiments may employ schema mapping to parse the structured data fields standardized schema that reflects the hierarchical relationships and dependencies among programs, projects, tasks, risks, and issues.

Clustering technique may be used to group project entities based on, for example, shared attributes, facilitating the identification of patterns and interdependencies across projects. For example, clustering may be performed by analyzing entities that share common locations. Similarly, entities associated with the same resource groups may be clustered to identify potential bottlenecks or overutilization of specific teams. Clustering by date ranges may also be used to highlight temporal dependencies and alignments, such as projects or tasks that coincide within a specific timeframe.

In step 210, the computer program may provide the structured data, the relationship information, and the grouping information to a dependency graph construction module, which, in step 215, may generate dependency graph and cluster information. For example, the dependency graph construction module may construct a Directed Acyclic Graph (DAG) where nodes of the DAG may represent project elements (e.g., milestones, tasks, risks, resources, etc.) and edges may represent dependencies, shared entities (e.g., the same resource group, location etc.), or sequential relationships between the project elements.

DAGs may be used to model the project dependencies, since dependencies often follow a non-cyclic, directional path (e.g., one project depends on another, but not vice versa). The DAG may be dynamically updated based on the changing project data over time.

The dependency graph construction module may then apply graph theory algorithms to the generated project graph to analyze interdependencies and identify potential bottlenecks, including, for example: (i) the shortest path algorithm to calculate the critical path across projects, determining the shortest timeline across inter-dependent tasks; (ii) centrality measures to identify critical tasks or milestones, by measuring the centrality of tasks in the dependency graph; (iii) clustering algorithms to identify clusters of project elements that share common attributes, such as locations impacted, resource groups from the program, project, and task tables to group nodes into clusters. For example, tasks that share the same resource group and overlap in start date and end date may be clustered together. This will help identify groups of interrelated tasks or projects that may require coordinated management to avoid resource conflicts.

The dependency graph construction module may use topological sorting to the nodes. In one embodiment, the dependency graph construction module may use the Parent ID fields in the schema to establish a directed edge from each task to its dependent tasks. For example, if a task in the task table has a Parent ID linking it to a project in the project table, the dependency graph construction module may create an edge from the project node to the task node. The dependency graph construction module may apply topological sorting to order these nodes, ensuring that each node appears before any nodes it points to, to determine the sequence of tasks and projects, respecting dependencies.

The dependency graph construction module may calculate centrality measurement (e.g., betweenness centrality for each node in the DAG). Nodes with high centrality scores, such as tasks or milestones that connect multiple projects or programs, may be identified as critical connectors. These nodes may be prioritized for resource allocation and monitoring.

The dependency graph construction module may also use an algorithm for finding the shortest paths between nodes in a weighted graph, to calculate the minimum cumulative duration from a starting task to a target task, considering the directed edges and task durations.

The dependency graph construction module may also use the Ford-Fulkerson method to find the maximum flow in the DAG. This helps identify where resources might be bottlenecked. By analyzing the flow of resources through various nodes and edges, the module can pinpoint areas where resources are constrained or overutilized.

The module may also utilize the PageRank algorithm to determine which tasks or milestones are most important in the graph. This helps identify tasks that greatly impact the project's flow and success. By looking at how connected and influential each task is, the module can locate key tasks that are crucial for project success.

In step 220, the computer program may provide the unstructured data received in step 205 to an insight extraction module, and in step 225, the insight extraction model may identify features and labels from the unstructured data, may add additional dependencies, etc. For example, the insight extraction module may use generative AI and/or LLM technology to identify insights from the unstructured data. The knowledge extracted from the unstructured data may also be used to suggest additional tasks based on, for example, lessons learned from historical content.

In embodiments, the insight extraction module may leverage natural language processing (NLP) and machine learning techniques. This may include tokenization, entity recognition and relationship extraction, dependency parsing, recognizing patterns and clustering, etc.

Tokenization may include breaking down the unstructured text from status reports, resolution updates, and descriptions into individual words or phrases (tokens) to facilitate analysis, Entity recognition and relationship extraction may include using NLP models to identify and classify entities within the text of status reports and resolution updates. Entities such as applications, teams and dates are extracted for further analysis.

Dependency parsing may include analyzing the grammatical structure of sentences in descriptions to identify relationships between entities. For example, extract the relationship between “A” and “dependency on B activities” to establish a link in the graph.

Recognizing patterns and clustering may include identifying common terms or phrases across multiple records, such as status reports and issue descriptions, to reveal related issues or events. For example, common terms/phrases such as “DMZ (Demilitarized Zone) network”, “extranet”, “proxy”, “NAT (Network Address Translation)”, and “firewall” are used to cluster related matters that are associated with external connectivity infrastructure. Records that mention similar entities or issues may be used to identify clusters or additional dependency links of the related nodes. Extracted entities and relationships from description, status reports and resolution updates may be used to create additional nodes and edges in the DAG.

In step 230, the computer program may enrich the dependency graph using a dependency graph enrichment module that enriches the dependency graph with the features and labels, and outputs an enriched dependency graph and enriched cluster information.

For example, the dependency graph enrichment module may issue prompts to the LLM, and may use the output from the LLM to enrich the DAG. In one embodiment, standard prompts may be used. For dependency identification, an example prompt may be “extract entities and relationships indicating dependencies from the status report that impact project timelines.” For risk assessment, an example prompt may be “identify risk-related entities, dates, and their potential impact on project outcomes from the updates.” For bottleneck detection, an example prompt may be “detect task entities and relationships that suggest potential bottlenecks in the descriptions.” For resource allocation, an example prompt may be “extract resource-related entities and their shared usage across tasks to identify overutilization.” For interdependency analysis, an example prompt may be “identify entities and relationships that indicate interdependencies between project X and project Y.” For event and entity recognition, an example prompt may be “extract new entities, locations, and dates from the project reports to update the graph.” Note that these prompts are exemplary only and additional and/or different prompts may be used as is necessary and/or desired.

In one embodiment, the dependency graph enrichment module may use the LLM to parse the unstructured context (e.g., a status report) to identify additional entities, relationships and events, and to add additional links and/or nodes to the graph.

For example, once the responses from the LLM are received, each node in the graph may carry attributes such as ID, location, date, impacted entities, predecessors, successors, category (task, milestone, risk, or issue, etc.).

In step 235, the computer program may make the enriched dependency graph and enriched cluster information available to a user electronic device via a user interface to a knowledge discovery module. The knowledge discovery module may present the analysis to users through the intuitive user interface that visualizes inter-dependencies, risks, and bottlenecks, including programming libraries (e.g., to present the graph, with nodes and edges dynamically updated based on the changes in project data); dashboards to provide real-time insights into project health, with visual indicators for critical dependencies and risks; and a chatbot-type interface to allow project managers to raise questions and simulate ‘what-if’ scenarios.

In step 240, the computer program may submit a query to the knowledge discovery module. In one embodiment, the user may interact with a chatbot, and may submit the query to the chatbot.

For example, the user may enter a natural language query related to a project. The query may range from specific questions about task dependencies to broader inquiries about project risks or resource allocation.

Once the query is received, the knowledge discovery module may use natural language processing to interpret the user's query and translate into a structured format that can be used to query the DAG graph. This may include mapping identified entities and relationships to their corresponding nodes and edges in the graph.

For example, the knowledge discovery module may map a task name to a specific node ID in the DAG and recognize “dependencies” as a request to trace incoming edges. This may include identifying the relevant node(s) in the DAG that correspond to the identified entities by searching the graph's data structure for noes that match the criteria specified in the query, and by traversing the DAG to explore the relationship between nodes and address the query. Generative artificial intelligence may be used.

For example, if the query is about risk or issue analysis, the knowledge discovery module may check for any risk or issue nodes linked to the target node through additional edges. This involves querying the graph for nodes classified as risks or issues that are connected to the target node, providing a comprehensive view of potential challenges.

Next, the knowledge discovery module may compile results. The results of the DAG query may be compiled into a response format that can be easily interpreted by the user. This includes a list of dependencies, dependent tasks, and any associated risks or issues. The knowledge discovery module may also generate visualization as required to provide a graphical representation of the relationships.

In step 245, the computer program may receive user feedback via the knowledge discovery module. The feedback may include metadata based on user and chatbot interaction.

For example, users may provide direct/explicit user feedback on whether the results were correct or incorrect. As another example, user feedback may be based on user behavior, such as by observing any additional questions or queries users make after receiving initial results, analyzing the amount of time the user spends reviewing the results, monitoring any actions users take after receiving results (e.g., updating the next project status reports with the information provided by the chatbot interface), etc. The user feedback—both explicit and inferred—may be used to refine the accuracy of the DAG graph.

In step 250, the computer program may provide the feedback from user to the data ingestion module, where it may be ingested, and may be used to update the DAG. For example, if a user repeatedly asks for information regarding a specific event of another project, this may mean that there is an uncovered link between the two projects in the DAG. As another example, the computer program may analyze common/related questions raised by large group of users that could potentially become a dynamic FAQ database as part of knowledge discovery module (e.g., a chatbot interface).

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine.

The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by a computer program executed in a platform, structured data and unstructured data from a data source for a project;
ingesting, by a data ingestion module, the structured data and the unstructured data;
providing, by the computer program, ingested structured data to a dependency graph construction module;
generating, by the dependency graph construction module, a Directed Acyclic Graph (DAG) and cluster information from the ingested structured data;
providing, by the computer program, the ingested unstructured data to an insights extraction module;
identifying, by the insights extraction module, features and labels from the ingested unstructured data;
outputting, by the insights extraction module, the features and labels to a dependency graph enrichment module;
enriching, by the dependency graph enrichment module, the DAG with the features and labels, resulting in an enriched DAG and enriched cluster information;
making, by the computer program, the enriched DAG and the enriched cluster information available to a user electronic device;
receiving, from a knowledge discovery module, user feedback from the user electronic device; and
providing, by the computer program, the user feedback to the data ingestion module.

2. The method of claim 1, wherein nodes of the DAG comprise project elements and edges represent dependencies or relationships between the project elements.

3. The method of claim 2, wherein the dependency graph construction module applies graph theory algorithms to analyze critical paths and identify clusters of project elements with common attributes.

4. The method of claim 1, wherein the insights extraction module comprises a large language model (LLM), wherein the LLM is configured to extract dependencies and relationships across events based on the ingested unstructured data.

5. The method of claim 1, wherein the insights extraction module is trained on historical data to identify bottlenecks and hidden dependencies using machine learning and natural language processing.

6. The method of claim 1, wherein the insights extraction module is configured to integrate graph algorithm outputs to forecast risks and recommend preventive actions.

7. The method of claim 1, further comprising:
providing, by the computer program, a visualization and chatbot interface on the user electronic device, wherein the visualization and chatbot interface provides analysis via insightful visualizations.

8. The method of claim 1, wherein the structured data comprises a program table for a program, a project table for a project in the program, a task table for tasks in the project, a risk table for risks in the project, an issue table for risks in the project, and a status report table for a status report for the project or program.

9. The method of claim 1, wherein the user feedback comprises explicit user feedback and inferred user feedback, and wherein the computer program updates the DAG graph using the user feedback.

10. The method of claim 1, further comprising:
generating, by the computer program, a dynamic frequently asked questions database based on the user feedback.

11. A non-transitory computer readable storage medium, including instructions stored thereon, which when read and executed by one or more computer processors, cause the one or more computer processors to perform steps comprising:
receiving structured data and unstructured data from a data source for a project;
ingesting the structured data and the unstructured data;
generating a Directed Acyclic Graph (DAG) and cluster information from the ingested structured data;
identifying features and labels from the ingested unstructured data;
enriching the DAG with the features and labels, resulting in an enriched dependency graph and enriched cluster information;
making the enriched DAG and the enriched cluster information available to a user electronic device; and
receiving user feedback from the user electronic device.

12. The non-transitory computer readable storage medium of claim 11, wherein nodes of the DAG comprise project elements and edges represent dependencies or relationships between the project elements.

13. The non-transitory computer readable storage medium of claim 12, further including instructions stored thereon, which when read and executed by one or more computer processors, cause the one or more computer processors to perform steps comprising: applying graph theory algorithms to analyze critical paths and identify clusters of project elements with common attributes.

14. The non-transitory computer readable storage medium of claim 11, wherein the identifying features and labels from the ingested unstructured data are identified using a large language model (LLM).

15. The non-transitory computer readable storage medium of claim 11, further including instructions stored thereon, which when read and executed by one or more computer processors, cause the one or more computer processors to perform steps comprising: integrating graph algorithm outputs to forecast risks and recommend preventive actions.

16. The non-transitory computer readable storage medium of claim 11, further including instructions stored thereon, which when read and executed by one or more computer processors, cause the one or more computer processors to perform steps comprising:
providing a visualization and chatbot interface on the user electronic device, wherein the visualization and chatbot interface provides analysis via insightful visualizations.

17. The non-transitory computer readable storage medium of claim 11, wherein the structured data comprises a program table for a program, a project table for a project in the program, a task table for tasks in the project, a risk table for risks in the project, an issue table for risks in the project, and a status report table for a status report for the project or program.

18. The non-transitory computer readable storage medium of claim 11, wherein the user feedback comprises explicit user feedback and inferred user feedback, and further including instructions stored thereon, which when read and executed by one or more computer processors, cause the one or more computer processors to perform steps comprising: updating the DAG graph using the user feedback.

19. The non-transitory computer readable storage medium of claim 11, further including instructions stored thereon, which when read and executed by one or more computer processors, cause the one or more computer processors to perform steps comprising:
generating a dynamic frequently asked questions database based on the user feedback.
